(19) United States
(12) Patent Application Publication
(10) Pub. No.: US 2025/0298674 A1
(43) Pub. Date: Sep. 25, 2025

(54) PHYSICAL RESOURCE LENDING SOURCE APPARATUS, PHYSICAL RESOURCE LENDING DESTINATION APPARATUS, AND PHYSICAL RESOURCE LENDING METHOD

(71) Applicant: NEC Corporation, Tokyo (JP)

(72) Inventor: Mitsuru MORIKAWA, Tokyo (JP)

(73) Assignee: NEC Corporation, Tokyo (JP)

(21) Appl. No.: 19/074,611

(22) Filed: Mar. 10, 2025

(30) Foreign Application Priority Data
Mar. 21, 2024 (JP) 2024-044863

(51) Int. Cl. G06F 9/50

(52) U.S. Cl. CPC G06F 9/5077

(57) ABSTRACT

The physical resource lending source apparatus includes: a resource management table storage unit configured to store a resource management table including, as items, a lendable physical resource, and a permitted tenant and a lending state being associated with the physical resource; a resource borrowing request acquisition unit configured to acquire a physical resource borrowing request being transmitted from a lending destination; a resource selection unit configured to select, based on the physical resource borrowing request, a physical resource to be lent to the lending destination from among the lendable physical resources; and a resource allocation unit configured to allocate the selected physical resource to a lending destination being a transmission source of the physical resource borrowing request.

### INCORPORATION BY REFERENCE

This application is based upon and claims the benefit of priority from Japanese patent application No. 2024-044863, filed on Mar. 21, 2024, the disclosure of which is incorporated herein in its entirety by reference.

### TECHNICAL FIELD

The present disclosure relates to a physical resource lending source apparatus, a physical resource lending destination apparatus, a physical resource lending method, and a physical resource lending program.

### BACKGROUND ART

A control apparatus that allows another user to use an excess band is known (for example, refer to Patent Literature 1).
[Patent Literature 1] Japanese Unexamined Patent Application Publication No. 2004-23312)

### SUMMARY

However, Patent Literature 1 does not include any description about managing a lending state (a state of availability) of a physical resource being borrowed by a user (a tenant, for example, a carrier) at a lending source of the physical resource, and there is room for improvement in this respect.

In view of the problem described above, an example object of the present disclosure is to provide a physical resource lending source apparatus, a physical resource lending destination apparatus, a physical resource lending method, and a physical resource lending program that make it possible to manage a lending state (a state of availability) of a physical resource being borrowed by a user (a tenant, for example, a carrier), at a lending source of the physical resource.

In a first example aspect, a physical resource lending source apparatus includes: a resource management table storage unit configured to store a resource management table including, as items, a lendable physical resource, and a permitted tenant and a lending state being associated with the physical resource; a resource borrowing request acquisition unit configured to acquire a physical resource borrowing request being transmitted from a lending destination; a resource selection unit configured to select, based on the physical resource borrowing request, a physical resource to be lent to the lending destination from among the lendable physical resources; and a resource allocation unit configured to allocate the selected physical resource to a lending destination being a transmission source of the physical resource borrowing request.

In a second example aspect, a physical resource lending destination apparatus includes: a resource borrowing request transmission unit configured to transmit a physical resource borrowing request to a lending source; an allocation result acquisition unit configured to acquire an allocation result being transmitted from the lending source in response to the physical resource borrowing request; and a path setting unit configured to perform path setting, based on the allocation result.

In a third example aspect, a physical resource lending method includes, by a computer: acquiring a physical resource borrowing request being transmitted from a lending destination; selecting, based on the physical resource borrowing request, a physical resource to be lent to the lending destination from among lendable physical resources included in a resource management table storage unit storing a resource management table that includes, as items, the lendable physical resources, and a permitted tenant and a lending state being associated with the physical resource; and allocating the selected physical resource to a lending destination being a transmission source of the physical resource borrowing request.

In a fourth example aspect, a non-transitory computer-readable medium storing a physical resource lending program causes a computer to execute: acquiring a physical resource borrowing request being transmitted from a lending destination; selecting, based on the physical resource borrowing request, a physical resource to be lent to the lending destination from among lendable physical resources included in a resource management table storage unit storing a resource management table that includes, as items, the lendable physical resources, and a permitted tenant and a lending state being associated with the physical resource; and allocating the selected physical resource to a lending destination being a transmission source of the physical resource borrowing request.

### BRIEF DESCRIPTION OF DRAWINGS

The above and other aspects, features, and advantages of the present disclosure will become more apparent from the following description of certain example embodiments when taken in conjunction with the accompanying drawings, in which:

An example advantage according to the above-described example embodiments is that it is possible to provide a physical resource lending source apparatus, a physical resource lending destination apparatus, a physical resource lending method, and a physical resource lending program that make it possible to manage a lending state (a state of availability) of a physical resource being borrowed by a user (a tenant, for example, a carrier), at a lending source of the physical resource.

FIG. 1 is a schematic configuration diagram of a physical resource lending source apparatus 10;

FIG. 2 is a flowchart of one example of an operation of the physical resource lending source apparatus 10;

FIG. 3 is a block diagram illustrating a configuration of a physical resource lending system 1;

FIG. 4 is a system configuration diagram of the physical resource lending source apparatus 10;

FIG. 5 is a functional block diagram of the physical resource lending source apparatus 10;

FIG. 6 is a system configuration diagram of a physical resource lending destination apparatus 20 (20A, 20B);

FIG. 7 is a flowchart of an operation example of the physical resource lending system 1;

FIG. 8A is examples of a resource management table T1;

FIG. 8B is examples of a resource management table T1;

FIG. 8C is examples of a resource management table T1;

FIG. 9 is a comparative example; and

FIG. 10 is a flowchart of an operation example of path setting.

### EXAMPLE EMBODIMENT

### First Example Embodiment

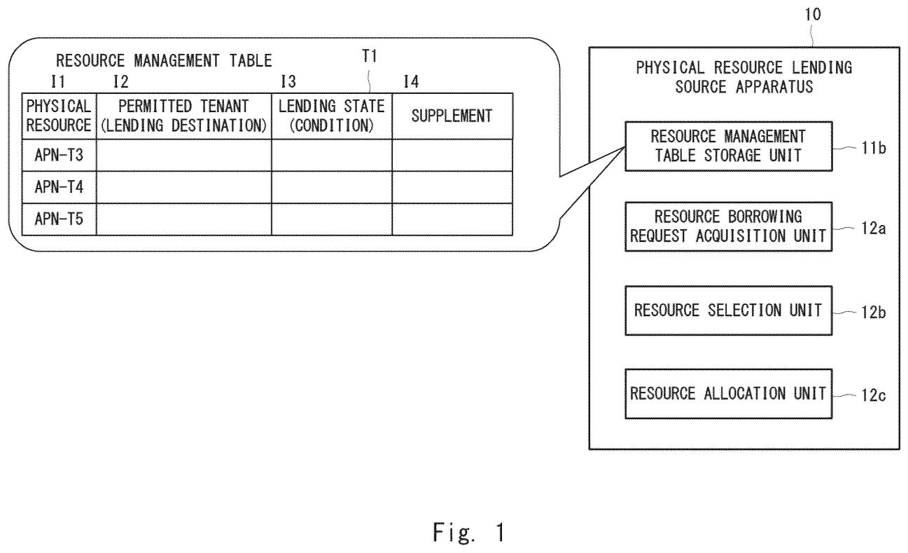

First, a physical resource lending source apparatus 10 according to the first example embodiment of the present disclosure is described with reference to FIG. 1.

FIG. 1 is a schematic configuration diagram of the physical resource lending source apparatus 10.

As illustrated in FIG. 1, the physical resource lending source apparatus 10 includes a resource management table storage unit 11b configured to store a resource management table including, as items, a lendable physical resource, and a permitted tenant and a lending state being associated with the physical resource, a resource borrowing request acquisition unit 12a configured to acquire a physical resource borrowing request being transmitted from a lending destination, a resource selection unit 12b configured to select, based on the physical resource borrowing request, a physical resource to be lent to the lending destination from among the lendable physical resources, and a resource allocation unit 12c configured to allocate the selected physical resource to the lending destination being the transmission source of the physical resource borrowing request.

Next, one example of an operation of the physical resource lending source apparatus 10 having the above-described configuration is described.

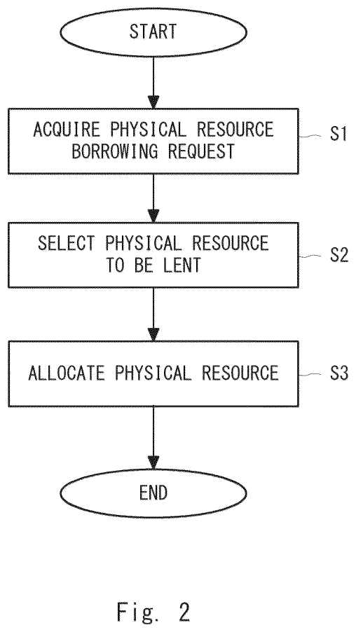

FIG. 2 is a flowchart of one example of an operation of the physical resource lending source apparatus 10.

First, the resource borrowing request acquisition unit 12a acquires a physical resource borrowing request being transmitted from a lending destination (step S1). Next, based on the physical resource borrowing request, the resource selection unit 12b selects a physical resource to be lent to the lending destination from among lendable physical resources (step S2). Then, the resource allocation unit 12c allocates the selected physical resource to the lending destination being the transmission source of the physical resource borrowing request (step S3). Specifically, the resource allocation unit 12c registers the lending destination and the lending state (available, which represents exclusive lending, or shareable, which represents shared lending) in a permitted tenant I2 and a lending state I3 that are included in the resource management table T1 and associated with the selected physical resource.

As described above, according to the first example embodiment, the lending state (state of availability) of the physical resource being borrowed by a user (tenant, for example, carrier) can be managed at the lending source (physical resource lending source apparatus 10) of the physical resource.

### Second Example Embodiment

First, a background of the second example embodiment is described. The second example embodiment is a more specific example embodiment of the first example embodiment.

Utilizing an all-photonics network (APN) enables high-capacity, low-latency servicing in end-to-end (E2E). Meanwhile, there is a problem that physical resources such as optical fibers/optical wavelengths are limited. Therefore, in order to achieve efficient utilization of physical resources that are in an idle state in a communication carrier, it is considered that “resource sharing” in which physical resources can be lent to other communication carriers may be requested in the future. Resource sharing may enable a communication carrier which borrows physical resources to deploy its own services by utilizing the borrowed physical resources, and to continue services even when a failure occurs, by borrowing physical resources for securing a detour route in the event of a failure.

In order to realize resource sharing, a communication carrier being the lending source needs to manage physical resources owned thereby in such a way that the physical resources can be lent to other carriers.

However, when a physical resource is lent to a lending destination communication carrier in an exclusive manner, the following problems may occur.

Firstly, in the lending destination communication carrier, a physical resource for a detour route secured in preparation for the occurrence of a failure is in an idle state when no failure occurs.

Secondly, the lending source communication carrier cannot efficiently lend out limited physical resources, resulting in a loss of business opportunities.

Therefore, when a physical resource is lent out at a lending source (apparatus or system), the lending is enabled in a form in which the usage right is not exclusive to a communication carrier being the lending destination but can be shared with other communication carriers. The shared physical resources can also be lent to other communication carriers.

The lending source system manages physical resource information in such a way that the physical resource can be specified by available or shareable, together with available tenant information, and the lending destination borrows a physical resource by specifying additional information (available or shareable).

Next, a physical resource lending system 1 including a physical resource lending source apparatus 10 and a physical resource lending destination apparatus 20 (20A, 20B) according to the second example embodiment of the present disclosure is described.

Hereinafter, as an example, a case is described in which a lending source of a physical resource is carrier A, lending destinations of the physical resource is carrier B and carrier C, and the physical resource to be lent is an open APN transceiver (APN-T). The APN-T is an end point of an optical wavelength path and has a function of transmitting and receiving an optical signal. The APN-Tis also referred to as a transponder.

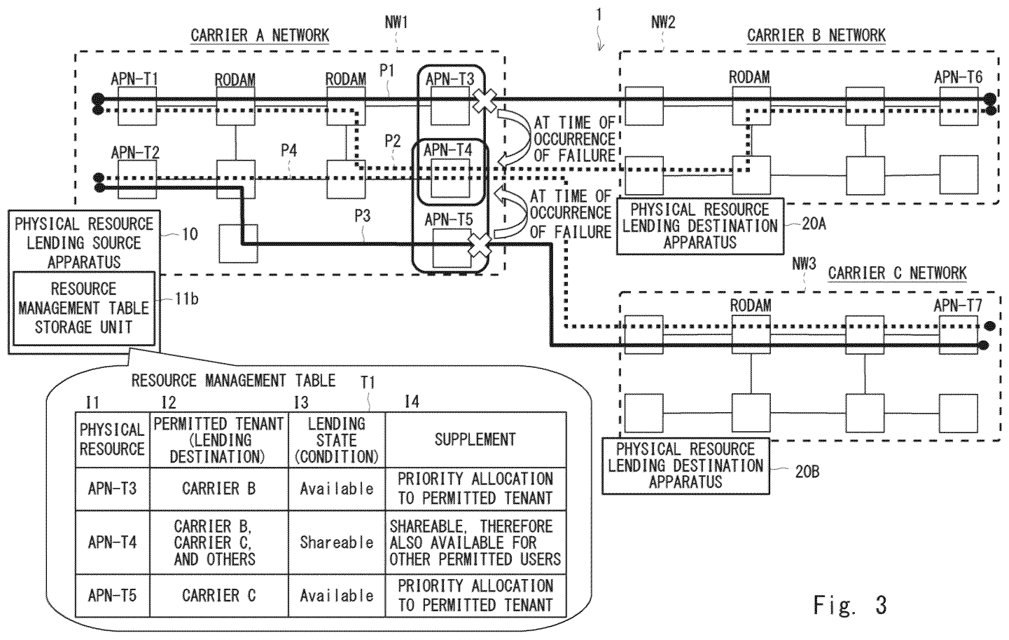

FIG. 3 is a block diagram illustrating a configuration of the physical resource lending system 1.

As illustrated in FIG. 3, the physical resource lending system 1 includes a carrier A network NW1, a carrier B network NW2, a carrier C network NW3, the physical resource lending source apparatus 10, and the physical resource lending destination apparatus 20 (20A, 20B).

The carrier A network NW1 is an optical network configured of a plurality of APN-Ts and reconfigurable optical add/drop multiplexer (ROADM) apparatuses. The ROADM apparatus demultiplexes a WDM signal to a plurality of optical transmission lines according to the wavelength, or multiplexes the optical signals input from the plurality of optical transmission lines to generate a WDM signal. Similarly, the carrier B network NW2 and the carrier C network NW3 are optical networks configured of a plurality of APN-Ts and ROADM apparatuses.

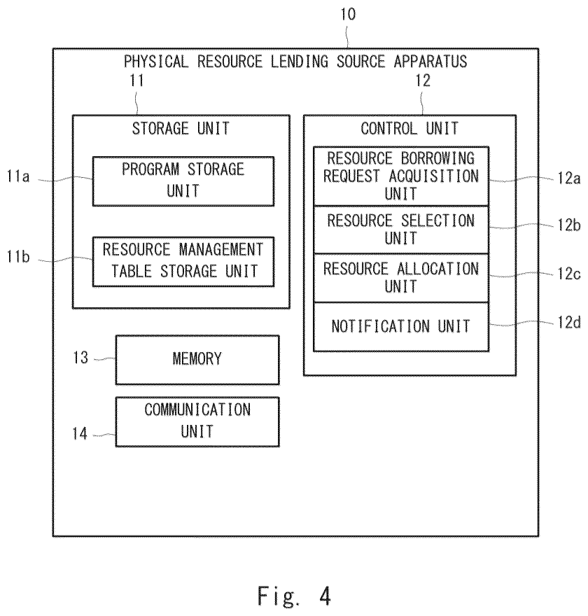

FIG. 4 is a system configuration diagram of the physical resource lending source apparatus 10.

As illustrated in FIG. 4, the physical resource lending source apparatus 10 includes a storage unit 11, a control unit 12, a memory 13, and a communication unit 14. The physical resource lending source apparatus 10 may be an information processing apparatus such as a personal computer or a server (physical server or virtual server), or may be a system in which a plurality of information processing apparatuses are appropriately combined.

The storage unit 11 is a non-volatile storage unit such as a hard disk apparatus or a ROM. The storage unit 11 includes a program storage unit 11a and a resource management table storage unit 11b.

The program storage unit 11a stores a program to be executed by the control unit 12 (processor).

As illustrated in FIG. 3, the resource management table storage unit 11b stores a resource management table T1. The resource management table T1 includes, as items, a physical resource I1, and a permitted tenant I2, a lending state I3, and a supplement I4 that are associated with the physical resource I1.

A lendable physical resource is registered (stored) in the physical resource I1. The lendable physical resource is, for example, a physical resource in an idle state which is not used by the carrier A. In FIG. 3, [APN-T3], [APN-T4], and [APN-T5] described in the physical resource I1 represent lendable physical resources. The lendable physical resource is input in advance by an operator of the carrier A and registered in the physical resource I1, for example.

Meanwhile, in the permitted tenant I2, a tenant (carrier or user) permitted to use the physical resource I1 associated thereto is registered.

Further, in the lending state I3, a lending state (state of availability) of the physical resource I1 associated thereto is registered. The lending state is, for example, available, which represents exclusive lending, or shareable, which represents shared lending. Supplementary information are registered in the supplement I4. Note that the supplement I4 may be omitted.

The control unit 12 includes a processor (not illustrated). The processor is, for example, a central processing unit (CPU). The processor may be a single processor or multiple processors. The processor executes the program read from the program storage unit 11a into the memory 13 (e.g., RAM), and thereby functions as a resource borrowing request acquisition unit 12a, a resource selection unit 12b, a resource allocation unit 12c, and a notification unit 12d, as illustrated in FIG. 4. Some or all of these functions may be implemented by hardware.

The resource borrowing request acquisition unit 12a acquires a physical resource borrowing request being transmitted from the lending destination (physical resource lending destination apparatus 20 (20A, 20B)). Specifically, the communication unit 14 receives the physical resource borrowing request being transmitted from the lending destination, and the resource borrowing request acquisition unit 12a acquires the physical resource borrowing request received by the communication unit 14. The physical resource borrowing request includes specification data specifying a borrowing condition (lending condition). The borrowing condition (lending condition) includes, for example, at least one of exclusive lending and shared lending, and the number of lending. In addition, as the borrowing condition (lending condition), for example, a wavelength (for example, specification of λ1 or the like), a resource (for example, specification of a transponder or a port included in the transponder), or the number of wavelengths (for example, specification of ten wavelengths or the like) may be used.

The resource selection unit 12b selects, based on the physical resource borrowing request acquired by the resource borrowing request acquisition unit 12a, a physical resource to be lent to the lending destination from among the lendable physical resources I1. For example, the resource selection unit 12b selects a physical resource (a physical resource conforming to a borrowing condition (lending condition)) to be lent to the lending destination from among the lendable physical resources I1, based on a borrowing condition (lending condition) specified by the specification data.

The resource allocation unit 12c allocates the physical resource selected by the resource selection unit 12b to the lending destination being the transmission source of the physical resource borrowing request. Specifically, the resource allocation unit 12c registers the lending source and the lending state (available, which represents exclusive lending, or shareable, which represents shared lending) in the permitted tenant I2 and the lending state I3 that are included in the resource management table T1 and associated with the physical resource I1 selected by the resource selection unit 12b.

In FIG. 3, the first row of the resource management table T1 is an example in which the [APN-T3], which is a physical resource being exclusively lent (available), is allocated to the [carrier B]. Meanwhile, the second row of the resource management table T1 is an example in which the [APN-T4], which is a physical resource being lent in a shareable manner, is allocated to the [carrier B, carrier C and others]. Further, the third row of the resource management table T1 is an example in which the [APN-T5], which is a physical resource being exclusively lent (available), is allocated to the [carrier C].

The notification unit 12d notifies the lending destination being the transmission source of the physical resource borrowing request of the allocation result via the communication unit 14. For example, the notification unit 12d notifies the carrier B, which is the lending destination being the transmission source of the physical resource borrowing request, of the [APN-T3], which is a physical resource being an available physical resource, as an allocation result. As described above, the allocation result notified to the lending destination being the transmission source of the physical resource borrowing request includes the allocated physical resource (physical resource identification information) and the lending state (exclusive lending (available) or shared lending (shareable)) of the allocated physical resource.

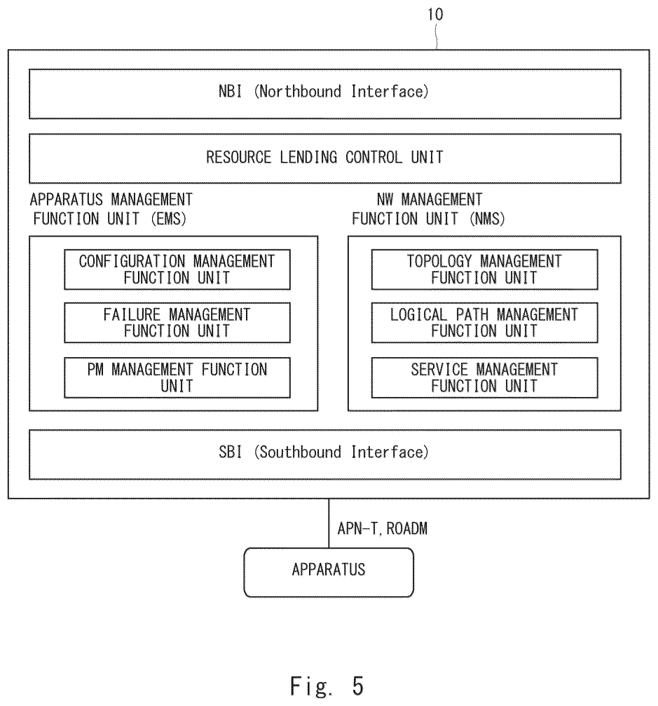

FIG. 5 is a functional block diagram of the physical resource lending source apparatus 10.

As illustrated in FIG. 5, an apparatus (APN-T(s), ROADM(s)) is connected to the physical resource lending source apparatus 10.

The processor executes the program read from the program storage unit 11a into the memory 13 (e.g., RAM), and thereby functions as a resource lending control unit, an apparatus management function unit (EMS) configured to manage the apparatus (APN-T(s), ROADM(s)), and an NE management function unit (NMS), as illustrated in FIG. 5. The resource borrowing request acquisition unit 12a, the resource selection unit 12b, the resource allocation unit 12c, and the notification unit 12d are examples of the resource lending control unit illustrated in FIG. 5. The apparatus management function unit (EMS) includes, for example, a configuration management function unit, a failure management function unit, and a PM management function unit. The NE management function unit (NMS) includes, for example, a topology management function unit, a logical path management function unit, and a service management function unit. Since these units are not directly related to the present disclosure, the description thereof is omitted.

The communication unit 14 is a communication apparatus for communicating with the physical resource lending destination apparatus 20 (20A, 20B) or the like via a predetermined network (not illustrated).

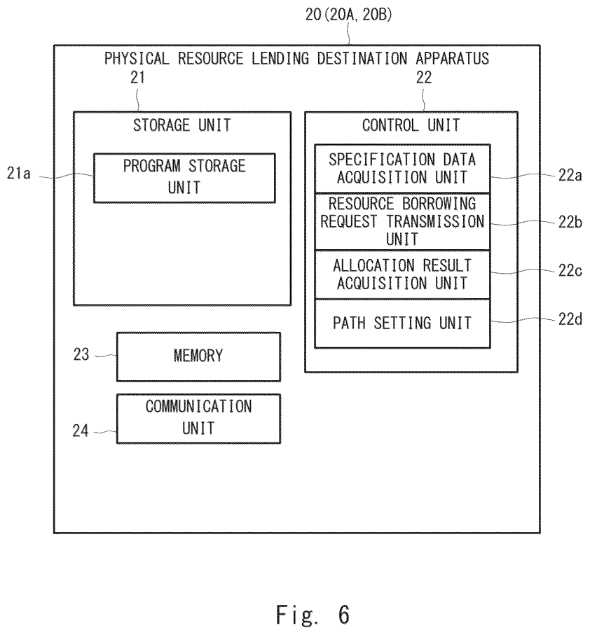

FIG. 6 is a system configuration diagram of the physical resource lending destination apparatus 20 (20A, 20B).

As illustrated in FIG. 6, the physical resource lending destination apparatus 20 (20A, 20B) includes a storage unit 21, a control unit 22, a memory 23, and a communication unit 24. The physical resource lending destination apparatus 20 (20A, 20B) may be an information processing apparatus such as a personal computer, a server (physical server or virtual server), or a system in which a plurality of information processing apparatuses are appropriately combined.

The storage unit 21 is a non-volatile storage unit such as a hard disk apparatus or a ROM. The storage unit 21 includes a program storage unit 21a.

The program storage unit 21a stores a program to be executed by the control unit 22 (processor).

The control unit 22 includes a processor (not illustrated). The processor is, for example, a central processing unit (CPU). The processor may be a single processor or multiple processors. The processor executes the program read from the program storage unit 21a into the memory 23 (e.g., RAM), and thereby functions as a specification data acquisition unit 22a, a resource borrowing request transmission unit 22b, an allocation result acquisition unit 22c, and a path setting unit 22d, as illustrated in FIG. 6. Some or all of the functions may be implemented by hardware.

The specification data acquisition unit 22a acquires specification data for specifying a borrowing condition (lending condition). The borrowing condition (lending condition) includes, for example, at least one of exclusive lending and shared lending, and the number of lending. For example, when specification data are input via an input screen (input screen including an API) being displayed on a display (not illustrated) upon clicking on a URL or the like or an input apparatus (not illustrated), the specification data acquisition unit 22a acquires the input specification data. The input apparatus is, for example, an input apparatus such as a keyboard.

The resource borrowing request transmission unit 22b transmits the physical resource borrowing request to the lending source via the communication unit 24. The physical resource borrowing request includes the specification data acquired by the specification data acquisition unit.

The specification data acquisition unit 22a and the resource borrowing request transmission unit 22b may be provided outside the physical resource lending destination apparatus 20 (20A, 20B).

The allocation result acquisition unit 22c acquires the allocation result being transmitted from the lending source (physical resource lending source apparatus 10) in response to the physical resource borrowing request. Specifically, the communication unit 24 receives the allocation result being transmitted from the lending source in response to the physical resource borrowing request, and the allocation result acquisition unit 22c acquires the allocation result received by the communication unit 24.

The path setting unit 22d performs path setting, based on the allocation result acquired by the allocation result acquisition unit 22c.

The communication unit 24 is a communication apparatus for communicating with the physical resource lending source apparatus 10 and the like via a predetermined network (not illustrated).

Similarly to the physical resource lending source apparatus 10, an apparatus (APN-T(s), ROADM(s)) is connected to the physical resource lending destination apparatus 20 (20A, 20B).

Similarly to the physical resource lending source apparatus 10, the processor functions as an apparatus management function unit (EMS) that manage the apparatus (APN-T(s), ROADM(s)) and an NE management function unit (NMS) by executing the program read from the program storage unit 21a into the memory 13 (e.g., RAM).

Next, an operation example of the physical resource lending system 1 having the above-described configuration is described.

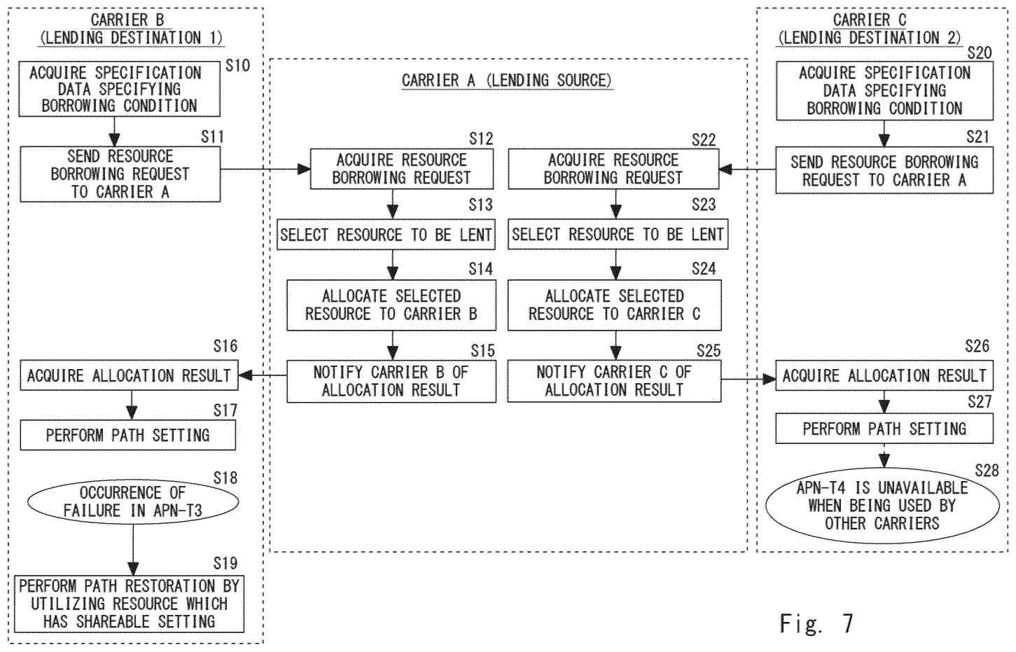

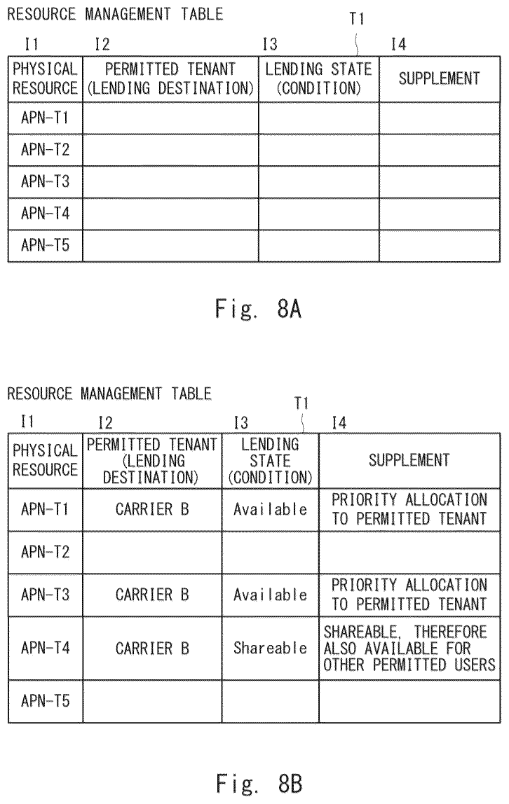

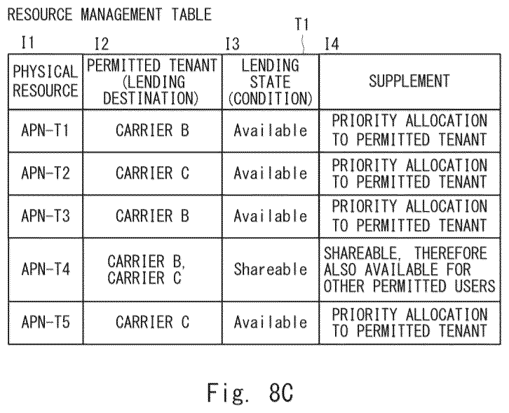

FIG. 7 is a flowchart of an operation example of the physical resource lending system 1. FIG. 8A to FIG. 8C are examples of the resource management table T1.

Hereinafter, as a premise, it is assumed that the [APN-T1] to [APN-T5] are registered as lendable physical resources in the physical resource I1 included in the resource management table T1, while nothing is registered in the permitted tenant I2, the lending state I3, and the supplementary I4 before starting processing of the flowchart illustrated in FIG. 7, as illustrated in FIG. 8A.

First, an operation example in a case where the carrier B (physical resource lending destination apparatus 20A) being the lending destination transmits a resource borrowing request to the carrier A (physical resource lending source apparatus 10) being the lending source is described.

First, the carrier B (physical resource lending destination apparatus 20A) acquires specification data specifying the borrowing condition (lending condition) (step S10). This is performed by the specification data acquisition unit 22a. In this example, [available: 2] and [shareable: 1] are specified as the specification data specifying the borrowing condition (lending condition). [Available: 2] represents a request for exclusive borrowing (exclusive lending) of two physical resources. [Shareable: 1] represents a request for shared borrowing (shared lending) of one physical resource.

Next, the carrier B (physical resource lending destination apparatus 20A) being the lending destination transmits a resource borrowing request to the carrier A (physical resource lending source apparatus 10) being the lending source (step S11). This is performed by the resource borrowing request transmission unit 22b. The resource borrowing request being transmitted herein includes the specification data acquired in step S10.

Next, the carrier A (physical resource lending source apparatus 10) being the lending source acquires (receives) the resource borrowing request transmitted from the carrier B (physical resource lending destination apparatus 20A) (step S12). This is performed by the resource borrowing request acquisition unit 12a.

Next, a physical resource to be lent to the carrier B being the lending destination is selected (step S13). This is performed by the resource selection unit 12b. Specifically, the resource selection unit 12b selects, based on a borrowing condition (lending condition) specified by the specification data, a physical resource (a physical resource conforming to a borrowing condition (lending condition)) to be lent to the carrier B being the lending destination from among the lendable physical resources I1. Herein, it is assumed that the APN-T1 and APN-T3 are selected as the physical resources to be exclusively lent to the carrier B, and the APN-T4 is selected as the physical resource to be lent in a shareable manner to the carrier B.

Next, the resource selected in step S13 is allocated to the carrier B that is the lending destination being the transmission source of the physical resource borrowing request (step S14). This is performed by the resource allocation unit 12c. Herein, the resource allocation unit 12c registers the lending destination [carrier B] and the lending state (available, which represents exclusive lending) in the permitted tenant I2 and the lending state I3, that are included in the resource management table T1 and associated with the [APN-T1] being the physical resource selected by the resource selection unit 12b (see FIG. 8B). Similarly, the resource allocation unit 12c registers the lending destination [carrier B] and the lending state (available, which represents exclusive lending) in the permitted tenant I2 and the lending state I3 that are included in the resource management table T1 and associated with the [APN-T3] being the physical resource selected by the resource selection unit 12b (see FIG. 8B).

Meanwhile, the resource allocation unit 12c registers the lending destination [carrier B] and the lending state (shareable, which represents shared lending) in the permitted tenant I2 and the lending state I3 that are included in the resource management table T1 and associated with the [APN-T4] being the physical resource selected by the resource selection unit 12b (see FIG. 8B).

Next, the allocation result is notified to the carrier B being the lending destination (step S15). This is performed by the notification unit 12d. The allocation result notified to the carrier B, which is the lending destination being the transmission source of the physical resource borrowing request, includes the [APN-T1] and [APN-T3], which are physical resources that are exclusively lent (available), and the [APN-T4], which is a physical resource that is lent in a shareable manner (shareable). As described above, the allocation result notified to the lending destination being the transmission source of the physical resource borrowing request includes the allocated physical resource (physical resource identification information) and the lending state (exclusive lending (available) or shared lending (shareable)) of the allocated physical resource.

Next, the carrier B (physical resource lending destination apparatus 20A) being the lending destination acquires the allocation result notified by the carrier A (step S16). This is performed by the allocation result acquisition unit 22c.

Next, path setting is performed (step S17). This is performed by the path setting unit 22d. Specifically, the path setting unit 22d performs path setting, based on the allocation result acquired in step S16. For example, the path setting unit 22d sets a path P1 (see FIG. 3) for normal use between the APN-T1 and the APN-T3 which are for exclusive lending.

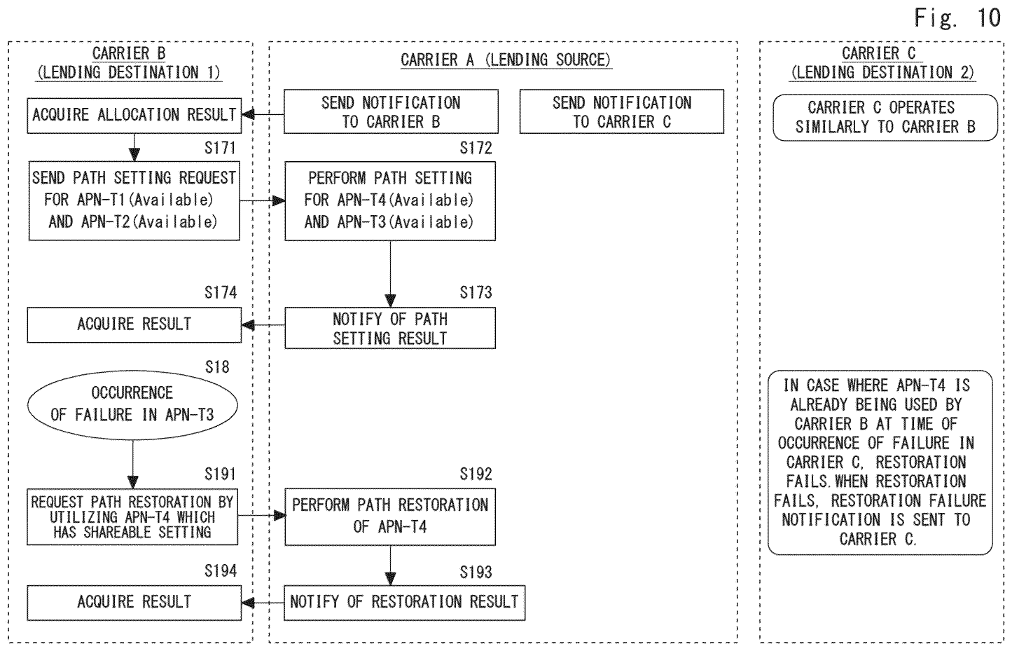

Details of this path setting are described with reference to FIG. 10. FIG. 10 is a flowchart of an operation example of path setting. Hereinafter, an operation example of path setting between the carrier B and the carrier A is described, but an operation example of path setting between carriers other than the carrier B (for example, the carrier C) and the carrier A is similar thereto.

First, the carrier B (physical resource lending destination apparatus 20A) that acquired the allocation result in step S16 transmits, to the carrier A (physical resource lending source apparatus 10), a path setting request of the [APN-T1] (available) and the [APN-T3] (available), which are physical resources that are exclusively lent (available), based on the allocation result (step S171).

Next, upon acquiring (receiving) the path setting request transmitted from the carrier B (physical resource lending destination apparatus 20A), the carrier A (physical resource lending source apparatus 10) refers to the resource management table T1, checks whether the carrier B is authorized to use the physical resource I1 (herein, APN-T1 and APN-T3), and if authorized, performs the path setting requested in step S171 (path setting of [APN-T1] (available) and [APN-T3] (available)) (step S172). As a result, the path P1 (see FIG. 3) for normal use is set between the APN-T1 and the APN-T3 which are for exclusive lending.

Next, the carrier A notifies the carrier B (physical resource lending destination apparatus 20A) of the path setting result (step S173). Then, the carrier B (physical resource lending destination apparatus 20A) acquires the path setting result notified by the carrier A (step S174).

Next, it is assumed that some kind of failure occurs in the APN-T3 in a state where the path P1 is set as described above (step S18).

In this case, the carrier B (physical resource lending destination apparatus 20A) utilizes the shareable physical resource (herein, APN-T4) to perform path restoration (step S19). As a result, a path P2 for the APN-T3 failure occurrence is set between the APN-T1 for exclusive lending and the APN-T4 for shared lending.

Details of the path restoration are described with reference to FIG. 10.

In a case where some kind of failure occurs in the APN-T3 in a state where the path P1 is set as described above (step S18), the carrier B (physical resource lending destination apparatus 20A) utilizes the APN-T4 and transmits a path restoration request to the carrier A (physical resource lending source apparatus 10) (step S191).

Next, upon acquiring (receiving) the path restoration request transmitted from the carrier B (physical resource lending destination apparatus 20A), the carrier A (physical resource lending source apparatus 10) refers to the resource management table T1, checks whether the carrier B is authorized to use the physical resource I1 (herein, APN-T4), and if authorized, performs the restoration (herein, restoration of [APN-T4]) requested in step S191 (step S192). As a result, the path P2 for the APN-T3 failure occurrence is set between the APN-T1 for exclusive lending and the APN-T4 for shared lending.

Next, an operation example in a case where the carrier C (physical resource lending destination apparatus 20B) being the lending destination transmits a resource borrowing request to the carrier A (physical resource lending source apparatus 10) being the lending source is described.

First, the carrier C (physical resource lending destination apparatus 20B) acquires specification data specifying the borrowing condition (lending condition) (step S20). This is performed by the specification data acquisition unit 22a. In this example, it is assumed that [available: 2] and [shareable: 1] are specified as the specification data specifying the borrowing condition (lending condition). [Available: 2] represents a request for exclusive borrowing (exclusive lending) of two physical resources. [Shareable: 1] represents a request for shared borrowing (shared lending) of one physical resource.

Next, the carrier C (physical resource lending destination apparatus 20B) being the lending destination transmits a resource borrowing request to the carrier A (physical resource lending source apparatus 10) being the lending source (step S21). This is performed by the resource borrowing request transmission unit 22b. The resource borrowing request being transmitted herein includes the specification data acquired in step S20.

Next, the carrier A (physical resource lending source apparatus 10) being the lending source acquires (receives) the resource borrowing request transmitted from the carrier C (physical resource lending destination apparatus 20B) (step S22). This is performed by the resource borrowing request acquisition unit 12a.

Next, a physical resource to be lent to the carrier C being the lending destination is selected (step S23). This is performed by the resource selection unit 12b. Specifically, the resource selection unit 12b selects, from among the lendable physical resources I1, a physical resource (a physical resource conforming to a borrowing condition (lending condition)) to be lent to the carrier C being a lending destination, based on the borrowing condition (lending condition) specified by the specification data. Herein, it is assumed that the APN-T2 and APN-T5 are selected as the physical resources to be exclusively lent to the carrier C, and the APN-T4 is selected as the physical resource to be lent to the carrier C in a shareable manner.

Next, the resource selected in step S23 is allocated to the carrier C that is the lending destination being the transmission source of the physical resource borrowing request (step S24). This is performed by the resource allocation unit 12c. Herein, the resource allocation unit 12c registers the lending destination [carrier C] and the lending state (available, which represents exclusive lending) in the permitted tenant I2 and the lending state I3 that are included in the resource management table T1 and associated with the [APN-T2] being the physical resource selected by the resource selection unit 12b (see FIG. 8C). Similarly, the resource allocation unit 12c registers the lending destination [carrier C] and the lending state (available, which represents exclusive lending) in the permitted tenant I2 and the lending state I3 that are included in the resource management table T1 and associated with the [APN-T5] being the physical resource selected by the resource selection unit 12b (see FIG. 8C).

Meanwhile, the resource allocation unit 12c registers the lending destination [carrier C] and the lending state (shareable, which represents shared lending) in the permitted tenant I2 and the lending state I3 that are included in the resource management table T1 and associated with the [APN-T4] being the physical resource selected by the resource selection unit 12b (see FIG. 8C).

Next, the allocation result is notified to the carrier C being the lending destination (step S25). This is performed by the notification unit 12d. The allocation result notified to the carrier C, which is the lending destination being the transmission source of the physical resource borrowing request, includes the [APN-T2] and [APN-T5], which are physical resources that are exclusively lent (available), and the [APN-T4], which is a physical resource that is lent in a shareable manner (shareable). As described above, the allocation result notified to the lending destination being the transmission source of the physical resource borrowing request includes the allocated physical resource (physical resource identification information) and the lending state (exclusive lending (available) or shared lending (shareable)) of the allocated physical resource.

Next, the carrier C (physical resource lending destination apparatus 20B) being the lending destination acquires the allocation result notified by the carrier A (step S26). This is performed by the allocation result acquisition unit 22c.

Next, path setting is performed (step S27). This is performed by the path setting unit 22d. Specifically, the path setting unit 22d performs path setting, based on the allocation result acquired in step S26. For example, the path setting unit 22d sets a path P3 (see FIG. 3) for normal use between the APN-T2 and the APN-T5 which are for exclusive lending.

Next, it is assumed that some kind of failure occurs in the APN-T5 in a state where the path P3 is set as described above.

At this time, if the carrier B is already using the shareable physical resource (herein, APN-T4) for path restoration, the carrier C cannot utilize the shareable physical resource (herein, APN-T4) (step S28).

For example, it is assumed that some kind of failure has occurred in the APN-T5 in a case where the path P2 for the APN-T3 failure occurrence is set between the APN-T1 for exclusive lending and the APN-T4 for shared lending as described above. In such a case, similarly to step S191, the carrier C (physical resource lending destination apparatus 20B) transmits a path restoration request to the carrier A (physical resource lending source apparatus 10) by utilizing the APN-T4.

Then, upon acquiring (receiving) the path restoration request transmitted from the carrier C (physical resource lending destination apparatus 20B), the carrier A (physical resource lending source apparatus 10) refers to the resource management table T1, checks whether the carrier C is authorized to use the physical resource I1 (herein, APN-T4), and if authorized, performs the restoration (herein, restoration of [APN-T4]) similarly to step S192.

However, herein, since the carrier B is already authorized to use the [APN-T4], the carrier cannot be authorized to use the [APN-T4]. As a result, the restoration (herein, restoration of [APN-T4]) is not performed. That is, the restoration fails. When the restoration fails in such a way, the carrier A sends to the carrier C the restoration result notification including the restoration failure.

On the other hand, when no other carrier are using the shareable physical resource (herein, APN-T4), the carrier C (physical resource lending destination apparatus 20B) performs path restoration by utilizing the shareable physical resource (herein, APN-T4) when a failure occurs in the APN-T5. As a result, a path P4 (see FIG. 3) for the APN-T5 failure occurrence is set between the APN-T2 for exclusive lending and the APN-T4 for shared lending.

Next, a comparative example is described.

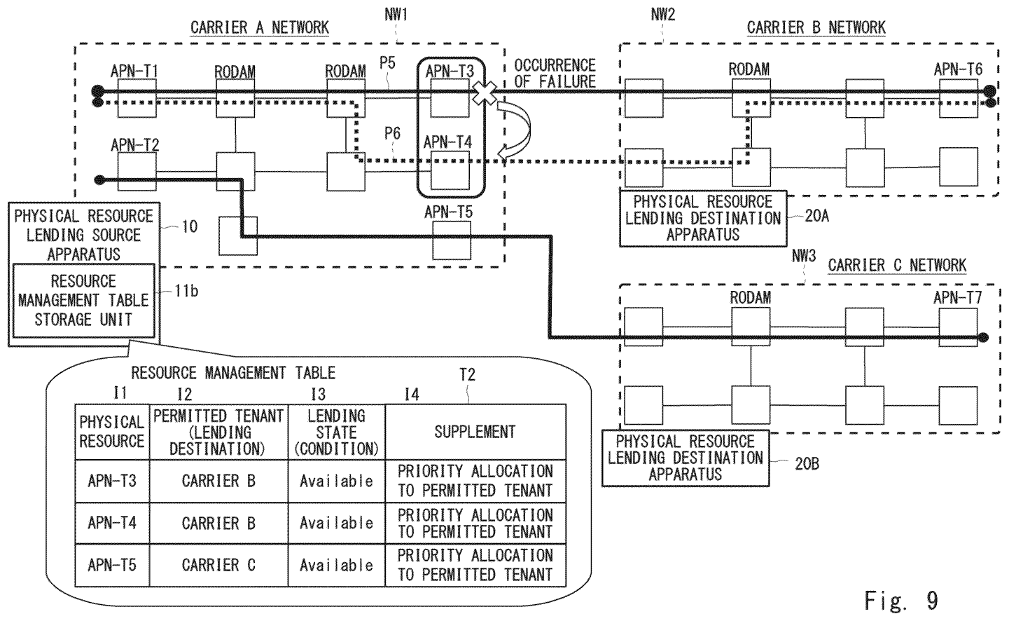

FIG. 9 is a comparative example.

The comparative example differs from the physical resource lending system 1 according to the second example embodiment in that the physical resource lending destination apparatus 20 (20A, 20B) is only capable of specifying exclusive lending and cannot specify shared lending, and that, as a result, available, which represents exclusive lending, is registered in the lending state I3 of the resource management table T1 in the physical resource lending source apparatus 10, and shareable, which represents shared lending, is not registered. Otherwise, the comparative example has a configuration similar to that of the physical resource lending system 1 according to the second example embodiment.

FIG. 9 illustrates a state in which the APN-T1, APN-T3, and APN-T4 are being exclusively lent to the carrier B, and a path P5 for normal use is set between the APN-T1 and the APN-T3.

In FIG. 9, the first and second rows of a resource management table T2 indicate that the [APN-T3] and [APN-T4], which are physical resources that are exclusively lent (available), are allocated to the [carrier B]. Similarly, the third row of the resource management table T2 indicates that the [APN-T5], which is a physical resource that is exclusively lent (available), is allocated to [carrier C].

In such a case, the carrier B performs path restoration, and thereby a path P6 for the APN-T3 failure occurrence is set between the APN-T1 and the APN-T4. Therefore, the E2E service can be continued even when a failure occurs.

However, since available, which represents exclusive lending, is registered in the lending state I3 of the resource management table T2 with respect to the APN-T4, there is a problem that the APN-T4 cannot be allocated to another carrier (for example, carrier C). Therefore, in the comparative example, there is a problem that the physical resource (herein, APN-T4) must be secured even when the service is not used, and the physical resource cannot be optimally used.

Meanwhile, according to the second example embodiment, since shareable, which represents shared lending, is registered in the lending state I3 of the resource management table T1 with respect to the APN-T4 (see FIG. 3), the APN-T4 can be allocated to another carrier (for example, the carrier C). Therefore, according to the second example embodiment, the physical resource can be optimally used.

As described above, according to the second example embodiment, the lending state (availability state) of the physical resource borrowed by the user (tenant, for example, carrier) can be managed at the lending source (physical resource lending source apparatus 10) of the physical resource.

Further, according to the second example embodiment, the lending destination communication carrier does not need to secure a physical resource for the detour route in preparation for the occurrence of a failure, and thus it is possible to prevent the physical resource in the lending destination communication carrier from becoming idle. In addition, even for the lending source communication carrier, limited physical resources can be efficiently lent to communication carriers.

Further, according to the second example embodiment, the state of availability of the physical resource to be borrowed by the user (tenant) can be managed (exclusive or shareable) by the lending source system.

Further, according to the second example embodiment, the tenant can specify all the physical resources to be borrowed as exclusive or shareable, and in the physical resource specified to be shareable, a plurality of tenants (no limit on the number thereof) can use the physical resource when necessary in a first-come basis. At that time, the physical resource can be used without requesting permission from a specific tenant. Note that, in case where a (first-come) tenant is using the physical resource specified to be shareable, other tenants cannot use this resource.

In the examples described above, the program includes instructions (or software code) that, when loaded into a computer, cause the computer to perform one or more of the functions described in the example embodiments. The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The present disclosure is not limited to the above-described example embodiments, and can be appropriately modified without departing from the scope of the present disclosure.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Each of the above-described example embodiments can be combined with other example embodiments as appropriate.

The drawings are merely illustrative of one or more example embodiments. Each drawing may be associated with one or more other example embodiments, rather than only one particular example embodiment. As those skilled in the art will appreciate, various features or steps described with reference to any one of the figures may be combined with features or steps illustrated in one or more other figures, for example, to create example embodiments not explicitly illustrated or described. All of the features or steps illustrated in any one of the figures to describe the example embodiments are not necessarily essential, and some features or steps may be omitted. The order of the steps described in any of the figures may be changed as appropriate.

Some or all of the above-described example embodiments may be described as the following supplementary notes, but are not limited thereto.

### Supplementary Note 1

A physical resource lending source apparatus including:
a resource management table storage unit configured to store a resource management table including, as items, a lendable physical resource, and a permitted tenant and a lending state being associated with the physical resource;
a resource borrowing request acquisition unit configured to acquire a physical resource borrowing request being transmitted from a lending destination;
a resource selection unit configured to select, based on the physical resource borrowing request, a physical resource to be lent to the lending destination from among the lendable physical resources; and
a resource allocation unit configured to allocate the selected physical resource to a lending destination being a transmission source of the physical resource borrowing request.

### Supplementary Note 2

The physical resource lending source apparatus according to supplementary note 1, wherein the resource allocation unit registers the lending destination and a lending state in the permitted tenant and the lending state that are included in the resource management table and associated with the selected physical resource.

### Supplementary Note 3

The physical resource lending source apparatus according to supplementary note 2, wherein the lending state is exclusive lending or shared lending.

### Supplementary Note 4

The physical resource lending source apparatus according to supplementary note 1, wherein the physical resource borrowing request includes specification data specifying a borrowing condition specified by the lending destination.

### Supplementary Note 5

The physical resource lending source apparatus according to supplementary note 4, wherein the borrowing condition includes at least one of exclusive lending and shared lending.

### Supplementary Note 6

The physical resource lending source apparatus according to supplementary note 5, wherein, in a case where the borrowing condition includes the shared lending, the resource allocation unit registers the lending destination and shared lending in the permitted tenant and the lending state that are associated with the selected physical resource.

### Supplementary Note 7

The physical resource lending source apparatus according to supplementary note 5, wherein, in a case where the borrowing condition includes the exclusive lending, the resource allocation unit registers the lending destination and exclusive lending in the permitted tenant and the lending state that are associated with the selected physical resource.

### Supplementary Note 8

The physical resource lending source apparatus according to supplementary note 1, further including a notification unit configured to notify the lending destination of an allocation result.

### Supplementary Note 9

The physical resource lending source apparatus according to supplementary note 8, wherein the allocation result includes an allocated physical resource and a lending state of the allocated physical resource.

### Supplementary Note 10

A physical resource lending destination apparatus including:
a resource borrowing request transmission unit configured to transmit a physical resource borrowing request to a lending source;
an allocation result acquisition unit configured to acquire an allocation result being transmitted from the lending source in response to the physical resource borrowing request; and
a path setting unit configured to perform path setting, based on the allocation result.

### Supplementary Note 11

A physical resource lending method including,
by a computer:
acquiring a physical resource borrowing request being transmitted from a lending destination;
selecting, based on the physical resource borrowing request, a physical resource to be lent to the lending destination from among lendable physical resources included in a resource management table storage unit storing a resource management table that includes, as items, the lendable physical resources, and a permitted tenant and a lending state being associated with the physical resource; and
allocating the selected physical resource to a lending destination being a transmission source of the physical resource borrowing request.

### Supplementary Note 12

A physical resource lending program causing a computer to execute:
acquiring a physical resource borrowing request being transmitted from a lending destination;
selecting, based on the physical resource borrowing request, a physical resource to be lent to the lending destination from among lendable physical resources included in a resource management table storage unit storing a resource management table that includes, as items, the lendable physical resources, and a permitted tenant and a lending state being associated with the physical resource; and
allocating the selected physical resource to a lending destination being a transmission source of the physical resource borrowing request.

Some or all of the elements (e.g., configurations and functions) described in Supplementary notes 2 to 9 depending on Supplementary note 1 may be dependent on Supplementary notes 10, 11, and 12 in dependency similar to that of Supplementary notes 2 to 9. Some or all of the elements described in any supplementary note may be applied to various hardware, software, recording means for recording software, systems, and methods.

What is claimed is:

1. A physical resource lending source apparatus comprising:
a resource management table storage unit configured to store a resource management table including, as items, a lendable physical resource, and a permitted tenant and a lending state being associated with the physical resource;
a resource borrowing request acquisition unit configured to acquire a physical resource borrowing request being transmitted from a lending destination;
a resource selection unit configured to select, based on the physical resource borrowing request, a physical resource to be lent to the lending destination from among the lendable physical resources; and
a resource allocation unit configured to allocate the selected physical resource to a lending destination being a transmission source of the physical resource borrowing request.

2. The physical resource lending source apparatus according to claim 1, wherein the resource allocation unit registers the lending destination and a lending state in the permitted tenant and the lending state that are included in the resource management table and associated with the selected physical resource.

3. The physical resource lending source apparatus according to claim 2, wherein the lending state is exclusive lending or shared lending.

4. The physical resource lending source apparatus according to claim 1, wherein the physical resource borrowing request includes specification data specifying a borrowing condition specified by the lending destination.

5. The physical resource lending source apparatus according to claim 4, wherein the borrowing condition includes at least one of exclusive lending and shared lending.

6. The physical resource lending source apparatus according to claim 5, wherein, in a case where the borrowing condition includes the shared lending, the resource allocation unit registers the lending destination and shared lending in the permitted tenant and the lending state that are associated with the selected physical resource.

7. The physical resource lending source apparatus according to claim 5, wherein, in a case where the borrowing condition includes the exclusive lending, the resource allocation unit registers the lending destination and exclusive lending in the permitted tenant and the lending state that are associated with the selected physical resource.

8. A physical resource lending destination apparatus comprising:
a resource borrowing request transmission unit configured to transmit a physical resource borrowing request to a lending source;
an allocation result acquisition unit configured to acquire an allocation result being transmitted from the lending source in response to the physical resource borrowing request; and
a path setting unit configured to perform path setting, based on the allocation result.

9. A physical resource lending method comprising,
by a computer:
acquiring a physical resource borrowing request being transmitted from a lending destination;
selecting, based on the physical resource borrowing request, a physical resource to be lent to the lending destination from among lendable physical resources included in a resource management table storage unit storing a resource management table that includes, as items, the lendable physical resources, and a permitted tenant and a lending state being associated with the physical resource; and
allocating the selected physical resource to a lending destination being a transmission source of the physical resource borrowing request.
